(19) United States
(12) Patent Application Publication
(10) Pub. No.: US 2025/0245550 A1
(43) Pub. Date: Jul. 31, 2025

(54) TELEMETRY DATA PROCESSING USING GENERATIVE MACHINE LEARNING

(71) Applicant: Microsoft Technology Licensing, LLC, Redmond, WA (US)

(72) Inventor: William David FRASIER, Lake Forest Park, WA (US)

(73) Assignee: Microsoft Technology Licensing, LLC, Redmond, WA (US)

(21) Appl. No.: 18/423,866

(22) Filed: Jan. 26, 2024

(51) Int. Cl. G06N 20/00

(52) U.S. Cl. CPC G06N 20/00

(57) ABSTRACT

Aspects of the present application relate to telemetry data processing using generative machine learning (ML). In examples, a prompt is generated that induces the generative ML model to interpret telemetry data according to the prompt. For instance, the prompt includes a semantic event index that defines a set of events relating to one or more issues, wherein each event is associated with a description and/or other context information for the event. An indication of the telemetry data may thus be provided for processing by the generative ML model. The generative ML model generates model output relating to the telemetry data, for example responsive to natural language input. Accordingly, the disclosed aspects may enable a developer or other user to converse with the generative ML model about telemetry data as though the model were the user.

### BACKGROUND

In examples, telemetry data is generated as a user operates a computing device. Such telemetry data may thus be reflective of the user's experience with software and/or hardware of the device. However, deriving meaning from the telemetry data may be challenging, for example requiring familiarity with the software/hardware (e.g., what events are reflected in the telemetry data), the user, and/or the task at hand. Additionally, the volume of telemetry data may make it impractical or impossible for manual review of the telemetry data, especially for a larger number of users, applications, and/or computing devices.

It is with respect to these and other general considerations that embodiments have been described. Also, although relatively specific problems have been discussed, it should be understood that the embodiments should not be limited to solving the specific problems identified in the background.

### SUMMARY

Aspects of the present application relate to telemetry data processing using generative machine learning (ML). In examples, a prompt is generated that induces the generative ML model to interpret telemetry data according to the prompt. For instance, the prompt includes a semantic event index that defines a set of events relating to one or more software and/or hardware issues, wherein each event is associated with a description and/or other context information for the event. An indication of the telemetry data may thus be provided for processing by the generative ML model. The generative ML model generates model output relating to the telemetry data, for example responsive to natural language input. Accordingly, the disclosed aspects may enable a developer or other user to converse with the generative ML model about telemetry data as though the model were the user.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates an overview of an example system in which telemetry data is processed using generative machine learning according to aspects of the present disclosure.

FIG. 1B illustrates an example conversation between a system user and a telemetry conversational agent according to aspects described herein.

FIG. 2 illustrates an overview of an example method for processing telemetry data using a generative machine learning model according to aspects described herein.

FIG. 3 illustrates an overview of an example method for processing multiple instances of telemetry data according to aspects described herein.

FIGS. 4A and 4B illustrate overviews of an example generative machine learning model that may be used according to aspects described herein.

FIG. 5 is a block diagram illustrating example physical components of a computing device with which aspects of the disclosure may be practiced.

FIG. 6 is a simplified block diagram of a computing device with which aspects of the present disclosure may be practiced.

FIG. 7 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, telemetry data may enable a software developer to diagnose software bugs, identify usability issues, and improve the user experience of the software. However, deriving meaning from the telemetry data may be difficult as, for example, the telemetry data may simply include an event, an identifier (e.g., of the device and/or the user), and a timestamp. Thus, such telemetry data may not, on its own, provide higher-level insight into the user's task at hand and/or other additional context. As a result, it may be difficult for the software developer to process the telemetry data in a way that yields an actionable conclusion. As another example, identifying trends (e.g., across users and/or devices) may be difficult, given that these and other challenges may further be exacerbated when attempting to analyze telemetry data for a larger number of users/devices.

Accordingly, aspects described herein relate to telemetry data processing using generative machine learning (ML). In examples, a prompt is generated that induces a generative ML model to interpret telemetry data according to the prompt. For instance, the prompt includes a semantic event index that defines a set of events relating to one or more software and/or hardware issues, wherein each event is associated with a description and/or other context information for the event. An indication of the telemetry data may thus be provided for processing by the generative ML model, for example as part of the prompt (e.g., as a list, a JavaScript Object Notation (JSON) object, and/or a table) and/or as a set of embeddings in a vectorized data store, among other examples. The generative ML model generates model output relating to the telemetry data, for example responsive to natural language input (e.g., also referred to herein as “conversational input,” as may be included in the prompt). As an example, the generative ML model may be questioned as part of a conversation, wherein the generative ML model produces responses based on the telemetry data and the semantic event index according to aspects described herein. Accordingly, the disclosed aspects may enable a developer or other user (also referred to herein as a “system user”) to converse with the generative ML model about telemetry data as though the generative ML model were the user for which the telemetry data was generated (also referred to herein as an “observed user” or an “end user”).

Thus, the semantic event index provides contextual information to the generative ML model, thereby enabling the model to attach meaning to events within telemetry data. Absent such a semantic event index, the model may lack the context with which to process telemetry data and thus the ability to produce model output that interprets the events contained therein. However, it will be appreciated that, in other examples, a finetuned ML model may be used in addition to or as an alternative to such a semantic event index, for example wherein the finetuned ML model is trained to have a specific understanding of telemetry data and associated events (e.g., for a specific application, suite of applications, and/or an execution environment as a whole).

Additionally, or alternatively, the prompt includes contextual information about the software execution environment (e.g., a type of software to which the telemetry data relates and/or a device type). In some examples, the prompt includes demographic information relating to the observed user and/or such demographic information may be generated by the generative ML model based on telemetry data according to aspects described herein. For example, the prompt may include an instructions to derive demographic information from the telemetry data and/or from a user profile, among other examples.

It will therefore be appreciated that a prompt generated according to the present disclosure may include any of a variety of information with which telemetry data is processed according to aspects described herein. In instances where the telemetry data is being used to identify a more specific issue, the generated prompt may include a semantic event index and/or context information that more specifically relates to the issue. Similarly, a sematic event index may include events relating to a specific application, to a suite of applications, and/or to an operating system, among other examples.

Additionally, while examples are described herein with respect to software telemetry data, it will be appreciated that similar techniques may be used to process telemetry data relating to hardware (e.g., where at least a part of the telemetry data relates to hardware events) or a combination of hardware and software, among other examples. Further, the disclosed aspects may be used to process telemetry data for any of a variety of applications, including, but not limited to, applications having a graphical user interface (e.g., comprised of user interface elements, such as buttons and text fields) and/or virtual environments (e.g., including three-dimensional objects, such as a video game). An instance of telemetry data may thus be referred to as being associated with a given execution environment (e.g., that includes any of a variety of hardware and/or software).

As an example, the telemetry data is generated for a web browser on a computing device. The telemetry data includes one or more events, for example a set of uniform resource locators (URLs) of a browsing session, as well as actuations of user interface elements of the web browser and/or of a webpage rendered by the web browser, among other examples. Accordingly, a semantic event index with which the telemetry data is processed includes one or more entries that each assign semantic meaning to a given URL, for example defining that a URL relates to a login page, to a support page, and/or to a contact us page. Thus, while an individual URL may have little semantic meaning to a generative ML model, the semantic event index improves understanding by the generative ML model for a given URL (and/or other events, in other examples).

Additionally, the semantic event index may describe an event as relating to a certain task and/or issue, among other examples. For example, one or more events of the semantic event index may be grouped as relating to a password reset attempt. The event grouping may thus enable the generative ML model to identify a higher-level task from a set of events within the telemetry data, such that telemetry data including such events is identified by the generative ML model as relating to an instance where a user is attempting to reset their password.

As another example, the semantic event index provides context relating to a software update, such that the generative ML model is primed to identify one or more events occurring after the software update as resulting from or otherwise being related to the software update. For instance, the semantic event index indicates one or more additional events to look for after identifying a given event. Thus, in addition to or as an alternative to enabling the detection of higher-level behaviors, the semantic event index enables a generative ML model to identify a cause and effect within the telemetry data. Such aspects may therefore facilitate discovery of issues caused by a software update and/or a misconfiguration, among other examples, such that they may more quickly be identified and addressed by the software developer.

It will be appreciated that the telemetry data processed according to the disclosed aspects need not be specifically generated for processing by a generative ML model. Rather, telemetry data from any of a variety of sources may be processed, for example as may be generated by an existing telemetry framework (e.g., as may be provided by an operating system) that is used by a first and/or third party, among other examples. As noted above, additional telemetry data may be generated that further improves processing by a generative ML model, for example indicating a higher-level task that is being performed (e.g., during which lower-level telemetry data may also be generated). For instance, the telemetry data may indicate user actuation of a variety of user interface elements (e.g., a pause/play button and/or a rewind button) and the telemetry data may additionally include an indication that the user is attempting to play a video or to return to a previous chapter in the video, among other examples.

In examples, a conversational agent is provided with which a system user can discuss telemetry data according to aspects described herein. In such an example, natural language input received from the system user (e.g., as text and/or speech) is processed by the generative ML model as part of a prompt (e.g., which may include the semantic event index and/or at least a part of the telemetry data), thereby generating model output that is responsive to the natural language input. At least a part of the model output is presented to the system user, such that the user and the conversational agent engage in a conversation accordingly.

As another example, interactions with such a conversational agent are automated, thereby enabling an automatic determination to be generated for a given instance of telemetry data. For example, a set of conversational inputs are provided to the conversational agent, such that a corresponding set of responses are generated by the generative ML model accordingly. The corresponding set of responses may thus be stored in association with the telemetry data in some examples.

Additionally, or alternatively, the set of responses are further processed, for example to categorize the telemetry data as exhibiting an issue selected from a set of issues and/or to provide troubleshooting instructions accordingly (e.g., as may have been generated by the generative ML model within the set of responses). In examples, the set of responses are similarly categorized by the generative ML model, such that the model evaluates the set of responses and selects a category from a set of categories accordingly.

Such automated conversational agent interactions may thus expedite telemetry data analysis. Additionally, such automated interactions may further be used to analyze multiple instances of telemetry data (e.g., from multiple observed users and/or computing devices), thereby enabling the identification of issues and/or trends across a larger sample size than just a single instance of telemetry data.

It will be appreciated that the disclosed aspects may be applied in any of a variety of other contexts (e.g., in addition to or as an alternative to a conversational agent with which a system user may interact and/or that is used to programmatically processes a set of conversational inputs). For example, a generative ML model is used to process telemetry data to perform user experience research, to evaluate reliability of a given instance of software and/or hardware, and/or as a trigger to initiate other device functionality. For instance, the disclosed aspects may be used to identify when a user (e.g., an end user) is performing a new task or using a computing device in a way that differs from previous interactions (e.g., based on processing performed by a generative ML model in view of a set of conversational inputs), such that the user is presented with a tutorial relating to the new task as a result of such a determination.

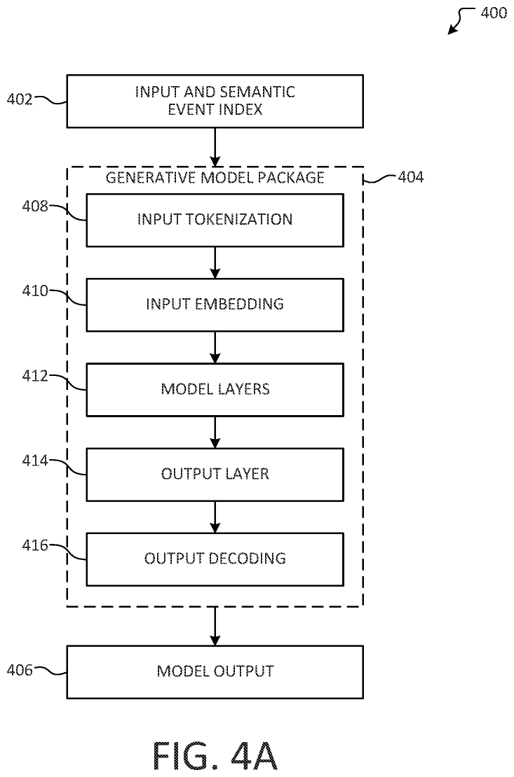

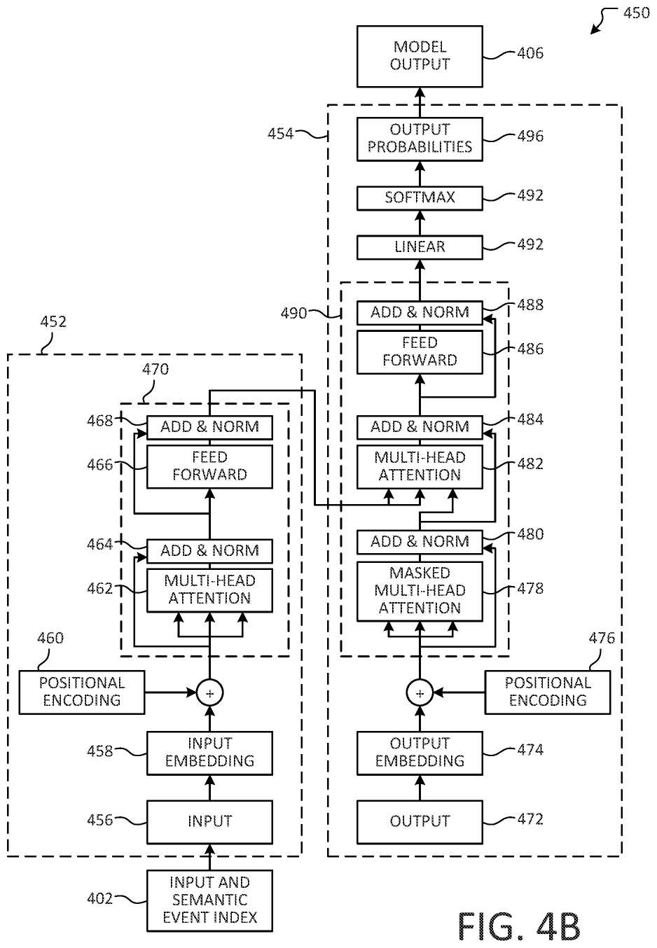

A generative ML model used according to aspects described herein may generate any of a variety of output types (and may thus be a multimodal generative model, in some examples) and may be a generative transformer model and/or a large language model (LLM), among other examples. Example models include, but are not limited to, Generative Pre-trained Transformer 3 (GPT-3), GPT-4, BigScience BLOOM (Large Open-science Open-access Multilingual Language Model), DALL-E 3, Stable Diffusion, or Jukebox. Additional examples of such aspects are discussed below with respect to the generative ML model illustrated in FIGS. 4A-4B.

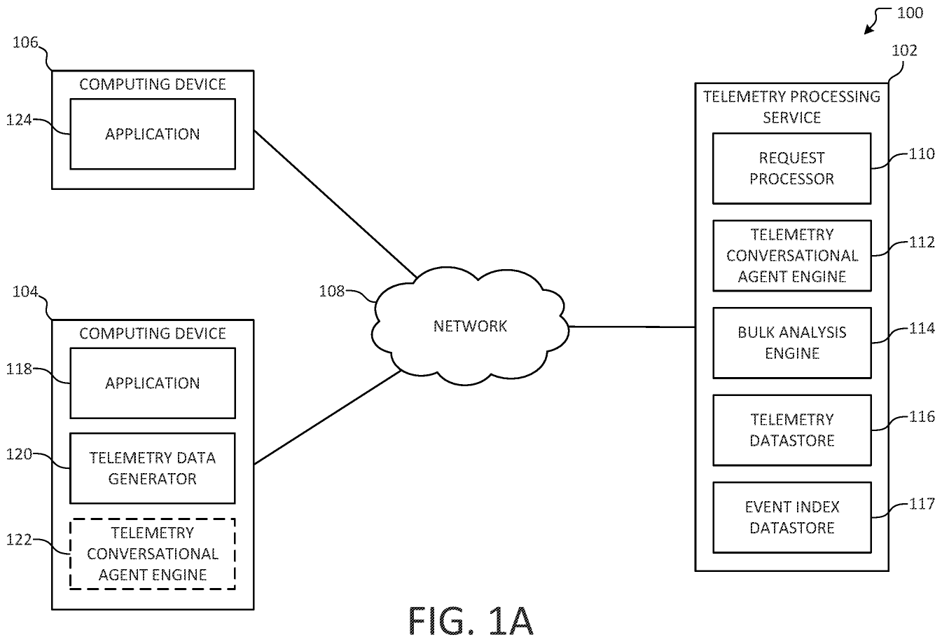

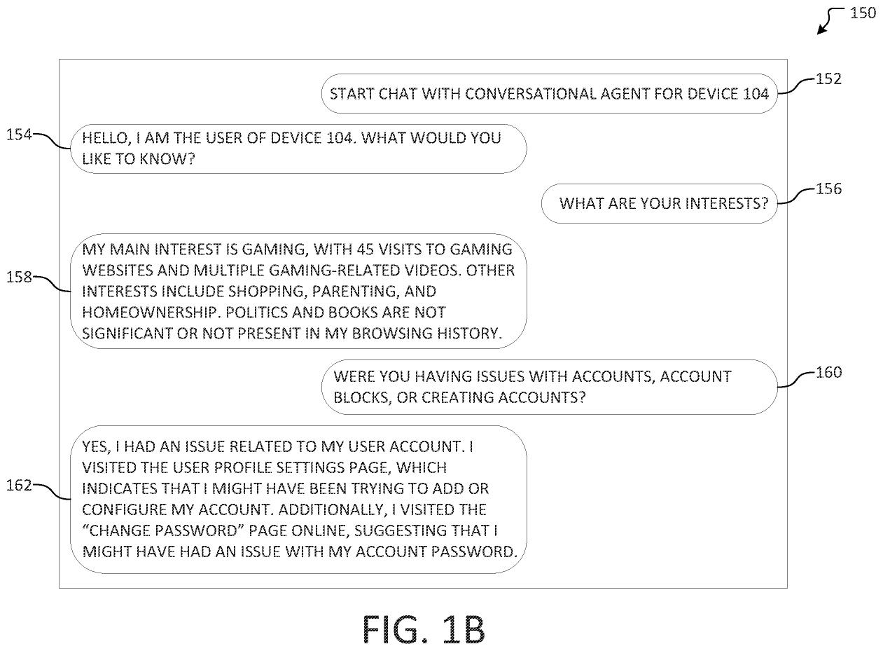

FIG. 1A illustrates an overview of an example system 100 in which telemetry data is processed using a generative ML model according to aspects of the present disclosure. As illustrated, system 100 includes telemetry processing service 102, computing device 104, computing device 106, and network 108. It will be appreciated that while system 100 is illustrated as including a single telemetry processing service 102 and a two computing devices 104 and 106, any number of such elements may be used in other examples. For instance, telemetry processing service 102 may process telemetry data from multiple computing devices in other examples. In examples, telemetry processing service 102, computing device 104, and/or computing device 106 communicate via network 108, which may comprise a local area network, a wireless network, or the Internet, or any combination thereof, among other examples.

As illustrated, telemetry processing service 102 includes request processor 110, telemetry conversational agent engine 112, bulk analysis engine 114, telemetry data store 116, and semantic event index 117. In examples, telemetry processing service 102 aggregates telemetry data from one or more computing devices (e.g., via request processor 110, as may be obtained from computing device 104), which may be stored in telemetry data store 116.

For example, telemetry data generator 120 of computing device 104 generates telemetry data for application 118. Telemetry data generator 120 may comprise a telemetry framework provided by an operating system of computing device 104. While telemetry data generator 120 is illustrated as separate from application 118, application 118 includes telemetry data generator 120 in other examples. As noted above, telemetry data generator 120 may generate telemetry data for an execution environment (e.g., including any of a variety of software and/or hardware) of computing device 104, which need not include application 118 in other examples.

Telemetry data generated by telemetry data generator 120 may include a number of entries corresponding to events for application 118. As an example, an event entry may include an event name, an indication of a user interface element (e.g., as may have been actuated by an observed user), an indication of a hardware button or other input control, an indication of a three-dimensional object within a virtual environment (e.g., which may have been subject to user interaction within the virtual environment), and/or an indication of a URL accessed by application 118, among other examples. Accordingly, telemetry data is sent from computing device 104 to telemetry processing service 102, for example such that it is stored in telemetry data store 116.

Telemetry conversational agent engine 112 provides a conversational agent with which a system user (e.g., of computing device 106) analyzes telemetry data (e.g., from telemetry data store 116) according to aspects described herein. For example, telemetry conversational agent engine 112 generates a prompt that includes a semantic event index (e.g., from event index datastore 117) and natural language input (e.g., as may be received from the user of computing device 106). In examples, event index datastore 117 stores one or more semantic event indices, each of which may correspond to a given execution environment (e.g., application 118 and/or computing device 104). While telemetry processing service 102 is illustrated as including event index datastore 117, it will be appreciated that the semantic event index may additionally, or alternatively, be obtained from any of a variety of other sources (e.g., computing device 104 and/or 106). The prompt is processed using a generative ML model (e.g., of telemetry processing service 102 or as may be provided by an ML service, not pictured, among other examples).

The generative ML model produces model output according to the prompt which, as noted above, thus interprets the telemetry data based on the semantic event index and natural language input of the prompt accordingly. In an example where the natural language input was received from computing device 106, at least a part of the model output is provided (e.g., via request processor 110) in response to the natural language input, such that it may be presented to the user via application 124. In examples, application 124 is a web browser that is used to access a webpage of telemetry processing service 102. As another example, application 124 is an application associated with telemetry processing service 102 and communicates with telemetry processing service 102 via an application programming interface (API), among other examples. Thus, the user of computing device 106 converses with telemetry conversational agent engine 112 to analyze telemetry data from one or more computing devices according to aspects described herein.

Telemetry processing service 102 is further illustrated as including bulk analysis engine 114, which programmatically uses telemetry conversational agent engine 112 to analyze one or more instances of telemetry data. For example, bulk analysis engine 114 iteratively provides conversational input from a set of pre-defined conversational inputs (e.g., as may have been defined by the user of computing device 106, for example via application 124) to telemetry conversational agent engine 112 (e.g., within a prompt for processing by a generative ML model). Resulting model output for each conversational input may be stored and/or further processed, for example to classify an instance of telemetry data as exhibiting a certain issue and/or user behavior, among other examples. As another example, model output and/or processing results are provided for display to a system user, for example to computing device 106 via application 124.

While system 100 is described in an example where telemetry data is generated at a first device (e.g., computing device 104) and analyzed using a second device (e.g., computing device 106), it will be appreciated that, in other examples, telemetry data may be generated and analyzed using the same device. For example, computing device 104 includes another application with which to communicate with telemetry processing service 102 (e.g., via an API of request processor 110), such that a user of computing device 104 may converse with telemetry conversational agent engine 112 and/or define a set of conversational inputs for bulk telemetry data processing, among other examples.

Computing device 104 is illustrated as further comprising telemetry conversational agent engine 122 in a dashed box to illustrate that, in some examples, at least a part of such processing may be performed local to a computing device (e.g., at which the telemetry data is generated). Similarly, such processing may use an ML service (e.g., remote from computing device 104) and/or may use local ML processing, among other examples. While not depicted, it will be appreciated that at least some of the processing performed by bulk analysis engine 114 may similarly be performed local to a computing device. For example, an application of computing device 104 may receive an indication from telemetry conversational agent engine 122 of an identified issue and/or behavior, such that the application may perform an action in response to the indication (e.g., displaying a new user tutorial and/or presenting troubleshooting suggestions). As another example, telemetry conversational agent engine 112 performs initial processing of telemetry data from telemetry data generator 120 (e.g., according to a set of conversational inputs) such that processing result(s) are provided to telemetry processing service 102 for storage and/or further processing. Such aspects may reduce the amount of telemetry data that is provided to telemetry processing service 102 and/or may improve user privacy, among other examples.

FIG. 1B illustrates an example conversation 150 between a system user and a telemetry conversational agent according to aspects described herein. For example, the system user may operate application 124 to engage in the depicted conversation with a telemetry conversational agent provided by telemetry conversational agent engine 112 of telemetry processing service 102. As illustrated, the inputs provided by the system user are messages 152, 156, and 160, while the responses generated by the telemetry conversational agent are messages 154, 158, and 162.

In the depicted conversation, the system user requests to discuss a specific instance of telemetry data in message 152, such that the telemetry conversational agent responds accordingly in message 154. Additionally, the system user is able to query the telemetry conversational agent about interests conveyed by the corresponding telemetry data in message 156, such that the telemetry conversational agent responds based on the telemetry data accordingly. Finally, the system user is also able to ask about potential issues encountered by the observed user (e.g., as indicated by the telemetry data), as shown in message 160. The telemetry conversational agent responds accordingly in message 162, where a response is generated based on the telemetry data and a corresponding semantic event index, which, in the present example, may associate an event relating to a “change password” page as corresponding to a password issue.

It will be appreciated that such aspects are provided for illustrative purposes and, in other examples, any of a variety of additional or alternative topics of conversation may be discussed with a telemetry conversational agent. Examples include, but are not limited to, how the observed user typically uses an application, asking about demographic information, asking about general issues encountered, and/or asking about specific detail relating to an identified issue, among other examples. Additionally, output of the telemetry conversational agent need not be limited to natural language output. For example, a telemetry conversational agent may additionally or alternatively produce output in JSON or as a common separated value (CSV) file, among other examples.

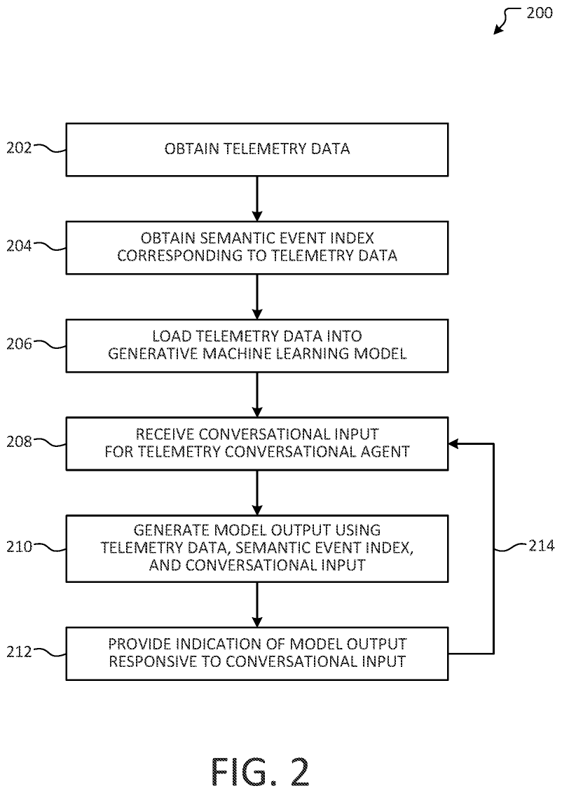

FIG. 2 illustrates an overview of an example method 200 for processing telemetry data using a generative ML model according to aspects described herein. In examples, aspects of method 200 are performed by a telemetry processing service, such as telemetry processing service 102 in FIG. 1A. In another example, at least a part of such aspects are performed local to a computing device, such as computing device 104 and/or 106, among other examples.

As illustrated, method 200 begins at operation 202, where telemetry data is obtained. In examples, telemetry data is obtained from a computing device (e.g., computing device 104 in FIG. 1A) and/or from a telemetry data store (e.g., telemetry data store 116), among other examples. As noted above, the telemetry data may relate to an execution environment, for example including an application, a suite of applications, an operating system, and/or computing hardware, among other examples. For instance, the telemetry data comprises a series of entries that each include an event, a device and/or user identifier, and a timestamp, though it will be appreciated that any of a variety of additional or alternative information may be included in other examples.

At operation 204, a semantic event index is obtained that corresponds to the telemetry data that was obtained at operation 202. In examples, the semantic event index is user-defined and includes one or more event definitions that each associate a description and/or context information with a given event defined therein. As an example, a system user identifies an event within telemetry data and provides a natural language description of the event, which is thus defined as an entry within the semantic event index accordingly. Accordingly, operation 204 comprises obtaining user input that defines one or more entries within the semantic event index. Additionally, or alternatively, a pre-defined semantic event index is accessed at operation 204.

Flow progresses to operation 206, where the telemetry data that was obtained at operation 202 is loaded for processing by the generative ML model. It will be appreciated that any of a variety of techniques may be used to load the obtained telemetry data, for example generating a set of embeddings that each correspond to an event of the telemetry data and/or generating a representation of the telemetry data to be incorporated into a prompt for the generative ML model. In other examples, operation 206 is omitted, as may be the case when method 200 is performed using an ML model that was finetuned for processing telemetry data according to aspects described herein.

Moving to operation 208, conversational input is received for processing by a telemetry conversational agent (e.g., as is comprised of processing by the generative ML model according to aspects described herein). In examples, the conversational input is received from a system user via an application of a computing device, such as application 124 of computing device 106 discussed above with respect to FIG. 1A. As another example, the conversational input is received as a set of pre-defined conversational inputs (e.g., as may have been pre-defined by a system user or otherwise obtained from a data store, for example for bulk processing of telemetry data). It will therefore be appreciated that the conversational input may be received from any of a variety of sources.

At operation 210, model output is generated based on the telemetry data, the semantic event index, and the conversational input. As an example, the semantic event index, the telemetry data, and the conversational input are used to generate a prompt for processing by the generative ML model, such that the generative ML model produces model output, thereby interpreting the telemetry data according to the conversational input accordingly. As noted above, a prompt processed by the generative ML model need not include the telemetry data, as may be the case when the telemetry data is instead used to generate a set of embeddings (e.g., as discussed above with respect to operation 206). Additionally, or alternatively, the prompt need not include the semantic event index, as may be the case when the generative ML model is a model that was finetuned for processing telemetry data according to aspects described herein.

Flow progresses to operation 212, where an indication of the model output is provided. For example, the indication is provided via an API for display to a user of a computing device from which the conversational input was received. Additionally, or alternatively, the model output is stored in association with the telemetry data and/or the conversational output. As a further example, the model output may be further processed, for example as part of a set of model outputs to categorize the telemetry data accordingly and/or to identify a trend within a larger number of instances of telemetry data, among other examples.

Arrow 214 is provided to illustrate that, in examples, method 200 loops between operations 208, 210, and 212, thereby providing a telemetry conversational agent with which a system user converses and/or software programmatically interacts to analyze the telemetry data according to aspects described herein. Eventually, method 200 terminates at operation 212.

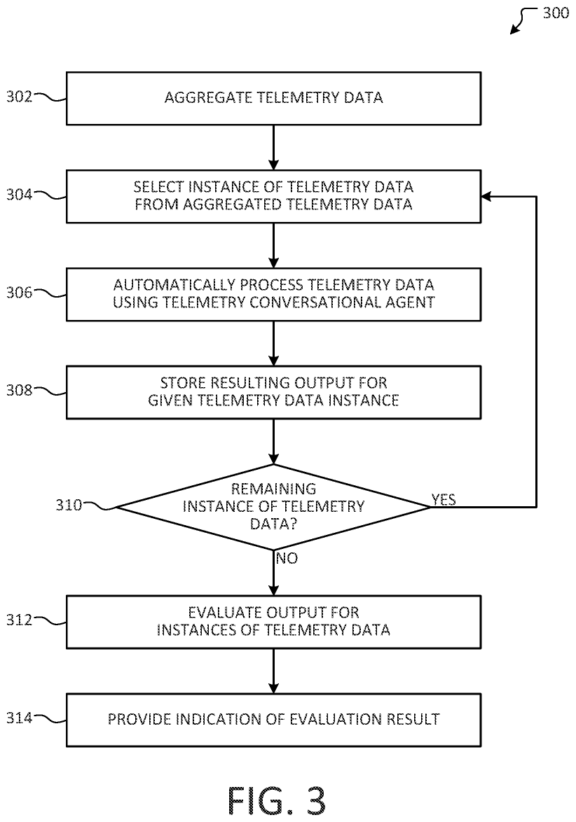

FIG. 3 illustrates an overview of an example method for processing multiple instances of telemetry data according to aspects described herein. In examples, aspects of method 300 are performed by a telemetry processing service, such as telemetry processing service 102 in FIG. 1A. In another example, at least a part of such aspects are performed local to a computing device, such as computing device 104 and/or 106, among other examples.

As illustrated, method 300 begins at operation 302, where telemetry data is aggregated. For example, a telemetry processing service (e.g., telemetry processing service 102 in FIG. 1A) receives telemetry data for one or more computing devices (e.g., computing device 104 and/or 106). In examples, the telemetry data relates to one or more observed users, applications, suites of applications, and/or operating systems, among other examples. Thus, it will be appreciated that any of a variety of telemetry data may be obtained at operation 302. In examples, the telemetry data is aggregated based on one or more shared characteristics, for example relating to the same or similar software application, the same or similar software version, and/or the same or similar type of computing device (e.g., mobile devices, tablet devices, laptop devices, and/or desktop devices).

Flow progresses to operation 304, where an instance of telemetry data is selected from the aggregated telemetry data. In examples, the telemetry data is selected based on an order in which the telemetry data was received and/or a date on which the telemetry data was generated. As another example, the instance of telemetry data is selected based on an order or a set of rules (e.g., as may be user-defined). As a further example, the instance of telemetry data is randomly selected. It will therefore be appreciated that any of a variety of techniques may be used to select the instance of telemetry data from the aggregated telemetry data according to aspects described herein.

Moving to operation 306, the telemetry data is automatically processed using a telemetry conversational agent according to aspects described herein. Aspects of operation 306 may be similar to those discussed above with respect to method 200 of FIG. 2 and are therefore not necessarily redescribed in detail. For example, a semantic event index is obtained that corresponds to the telemetry data instance (e.g., similar to operation 204 discussed above with respect to method 200 of FIG. 2), the telemetry data is loaded for processing by a generative ML model (e.g., similar to operation 206), and a prompt is generated that includes conversational input, such that model output is generated accordingly (e.g., similar to operation 210). Operation 306 may comprise iterating through a set of conversational inputs (e.g., similar to the loop between operations 208, 210, and 212 depicted in method 200), such that a corresponding set of model outputs are generated accordingly.

At operation 308, the resulting output is stored in association with the telemetry data instance. While method 300 is illustrated as an example where model output from the telemetry conversational agent is stored at operation 308, it will be appreciated that any of a variety of alternative or additional operations may be performed. For example, the set of model outputs is further processed to summarize the model output and/or to categorize the telemetry data instance accordingly, among other examples. Such a summarization and/or categorization may be stored at operation 308 in addition to or as an alternative to the set of model outputs in some examples.

Method 300 progresses to determination 310, where it is determined whether there is a remaining instance of telemetry data to process. If there is, flow branches “YES” and returns to operation 304, such that method 300 iterates through operations 304, 306, 308, and 310 to programmatic process the telemetry data instances of the aggregated telemetry data accordingly.

However, if there is no remaining telemetry data to process, flow instead branches “NO” to operation 312, where the corresponding processing result(s) for each instance of telemetry data that was processed as a result of iterating through operations 304, 306, 308, and 310 is further processed. For example, operation 312 may comprise further evaluating the processing result(s) to identify a trend and/or a set of events have a resulting category (e.g., thereby indicating a potential issue), among other examples. In examples, processing performed at operation 312 comprises providing an indication of the processing results for the aggregated telemetry data as part of a prompt that is then further processed by the generative ML model according to aspects described herein. It will therefore be appreciated that any of a variety of additional and/or alternative processing may be performed at operation 312 to generate an evaluation result accordingly.

Finally, at operation 314, an indication of the evaluation result is provided. For example, the evaluation result may be provided for display to a user (e.g., via application 124 of computing device 106 in FIG. 1A). Additionally, or alternatively, the evaluation result is stored in a datastore for later retrieval and/or subsequent processing, among other examples. While example operations are described, it will be appreciated that any of a variety of additional or alterative operations may be performed in other examples. Method 300 terminates at operation 314.

FIGS. 4A and 4B illustrate overviews of an example generative machine learning model that may be used according to aspects described herein. With reference first to FIG. 4A, conceptual diagram 400 depicts an overview of pre-trained generative model package 404 that processes an input and semantic event index 402 to generate model output 406 that interprets the telemetry data according to aspects described herein.

In examples, generative model package 404 is pre-trained according to a variety of inputs (e.g., a variety of human languages, a variety of programming languages, and/or a variety of content types) and therefore need not be finetuned or trained for a specific scenario. Rather, generative model package 404 may be more generally pre-trained, such that input 402 includes a prompt that is generated, selected, or otherwise engineered to induce generative model package 404 to produce certain generative model output 406. It will be appreciated that input 402 and generative model output 406 may each include any of a variety of content types, including, but not limited to, text output, image output, audio output, video output, programmatic output, and/or binary output, among other examples. In examples, input 402 and generative model output 406 may have different content types, as may be the case when generative model package 404 includes a generative multimodal machine learning model.

As such, generative model package 404 may be used in any of a variety of scenarios and, further, a different generative model package may be used in place of generative model package 404 without substantially modifying other associated aspects (e.g., similar to those described herein with respect to FIGS. 1, 2, and 3). Accordingly, generative model package 404 operates as a tool with which machine learning processing is performed, in which certain inputs 402 to generative model package 404 are programmatically generated or otherwise determined, thereby causing generative model package 404 to produce model output 406 that may subsequently be used for further processing.

Generative model package 404 may be provided or otherwise used according to any of a variety of paradigms. For example, generative model package 404 may be used local to a computing device (e.g., computing device 104 and/or 106 in FIG. 1A) or may be accessed remotely from a machine learning service (e.g., telemetry processing service 102). In other examples, aspects of generative model package 404 are distributed across multiple computing devices. In some instances, generative model package 404 is accessible via an API, as may be provided by an operating system of the computing device and/or by the machine learning service, among other examples.

With reference now to the illustrated aspects of generative model package 404, generative model package 404 includes input tokenization 408, input embedding 410, model layers 412, output layer 414, and output decoding 416. In examples, input tokenization 408 processes input 402 to generate input embedding 410, which includes a sequence of symbol representations that corresponds to input 402. Accordingly, input embedding 410 is processed by model layers 412, output layer 414, and output decoding 416 to produce model output 406. An example architecture corresponding to generative model package 404 is depicted in FIG. 4B, which is discussed below in further detail. Even so, it will be appreciated that the architectures that are illustrated and described herein are not to be taken in a limiting sense and, in other examples, any of a variety of other architectures may be used.

FIG. 4B is a conceptual diagram that depicts an example architecture 450 of a pre-trained generative machine learning model that may be used according to aspects described herein. As noted above, any of a variety of alternative architectures and corresponding ML models may be used in other examples without departing from the aspects described herein.

As illustrated, architecture 450 processes input 402 to produce generative model output 406, aspects of which were discussed above with respect to FIG. 4A. Architecture 450 is depicted as a transformer model that includes encoder 452 and decoder 454. Encoder 452 processes input embedding 458 (aspects of which may be similar to input embedding 410 in FIG. 4A), which includes a sequence of symbol representations that corresponds to input 456. In examples, input 456 includes input and semantic event index 402 corresponding to telemetry data for which model output is to be generated, similar to aspects discussed above with respect to telemetry conversational agent engine 112 and/or bulk analysis engine 114 in FIG. 1A, for example by performing aspects of operations 202-212 and/or operations 302-314 in FIGS. 2 and 3, respectively.

Further, positional encoding 460 may introduce information about the relative and/or absolute position for tokens of input embedding 458. Similarly, output embedding 474 includes a sequence of symbol representations that correspond to output 472, while positional encoding 476 may similarly introduce information about the relative and/or absolute position for tokens of output embedding 474.

As illustrated, encoder 452 includes example layer 470. It will be appreciated that any number of such layers may be used, and that the depicted architecture is simplified for illustrative purposes. Example layer 470 includes two sub-layers: multi-head attention layer 462 and feed forward layer 466. In examples, a residual connection is included around each layer 462, 466, after which normalization layers 464 and 468, respectively, are included.

Decoder 454 includes example layer 490. Similar to encoder 452, any number of such layers may be used in other examples, and the depicted architecture of decoder 454 is simplified for illustrative purposes. As illustrated, example layer 490 includes three sub-layers: masked multi-head attention layer 478, multi-head attention layer 482, and feed forward layer 486. Aspects of multi-head attention layer 482 and feed forward layer 486 may be similar to those discussed above with respect to multi-head attention layer 462 and feed forward layer 466, respectively. Additionally, masked multi-head attention layer 478 performs multi-head attention over the output of encoder 452 (e.g., output 472). In examples, masked multi-head attention layer 478 prevents positions from attending to subsequent positions. Such masking, combined with offsetting the embeddings (e.g., by one position, as illustrated by multi-head attention layer 482), may ensure that a prediction for a given position depends on known output for one or more positions that are less than the given position. As illustrated, residual connections are also included around layers 478, 482, and 486, after which normalization layers 480, 484, and 488, respectively, are included.

Multi-head attention layers 462, 478, and 482 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 4B (e.g., by a corresponding normalization layer 464, 480, or 484).

Feed forward layers 466 and 486 may each be a fully connected feed-forward network, which applies to each position. In examples, feed forward layers 466 and 486 each include a plurality of linear transformations with a rectified linear unit activation in between. In examples, each linear transformation is the same across different positions, while different parameters may be used as compared to other linear transformations of the feed-forward network.

Additionally, aspects of linear transformation 492 may be similar to the linear transformations discussed above with respect to multi-head attention layers 462, 478, and 482, as well as feed forward layers 466 and 486. Softmax 494 may further convert the output of linear transformation 492 to predicted next-token probabilities, as indicated by output probabilities 496. It will be appreciated that the illustrated architecture is provided in as an example and, in other examples, any of a variety of other model architectures may be used in accordance with the disclosed aspects.

Accordingly, output probabilities 496 may thus form model output 406 according to aspects described herein, such that the output of the generative ML model (e.g., which may thus interpret provided telemetry data according to the provided conversational input and semantic event index) is used, for example, processed to further categorize the telemetry data and/or identify issues/trends according to aspects described herein.

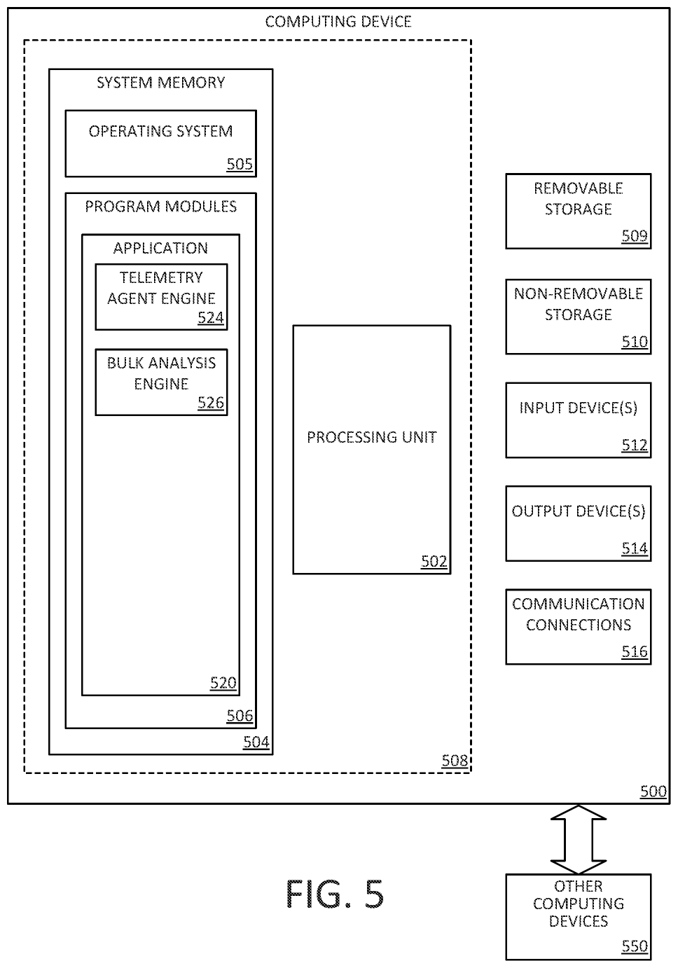

FIGS. 5-7 and the associated descriptions provide a discussion of a variety of operating environments in which aspects of the disclosure may be practiced. However, the devices and systems illustrated and discussed with respect to FIGS. 5-7 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including one or more devices associated with telemetry processing service 102, as well as computing devices 104 and/or 106 discussed above with respect to FIG. 1A. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may telemetry agent engine 524 and bulk analysis engine 526. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

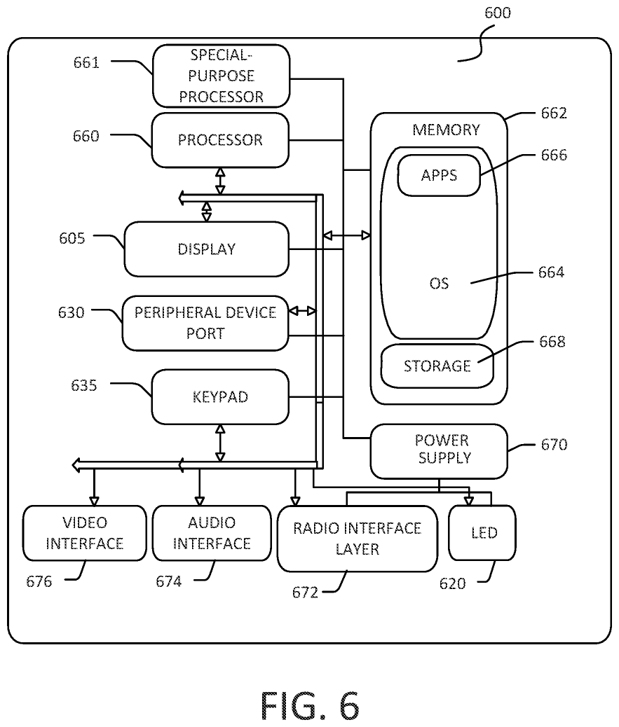

FIG. 6 illustrates a system 600 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 600 is implemented as a “smart phone” capable of running one or more applications (e.g., browser, e-mail, calendaring, contact managers, messaging clients, games, and media clients/players). In some aspects, the system 600 is integrated as a computing device, such as an integrated personal digital assistant (PDA) and wireless phone.

In a basic configuration, such a mobile computing device is a handheld computer having both input elements and output elements. The system 600 typically includes a display 605 and one or more input buttons that allow the user to enter information into the system 600. The display 605 may also function as an input device (e.g., a touch screen display).

If included, an optional side input element allows further user input. For example, the side input element may be a rotary switch, a button, or any other type of manual input element. In alternative aspects, system 600 may incorporate more or less input elements. For example, the display 605 may not be a touch screen in some embodiments. In another example, an optional keypad 635 may also be included, which may be a physical keypad or a “soft” keypad generated on the touch screen display.

In various embodiments, the output elements include the display 605 for showing a graphical user interface (GUI), a visual indicator (e.g., a light emitting diode 620), and/or an audio transducer 625 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 600 also includes a non-volatile storage area 668 within the memory 662. The non-volatile storage area 668 may be used to store persistent information that should not be lost if the system 600 is powered down. The application programs 666 may use and store information in the non-volatile storage area 668, such as e-mail or other messages used by an e-mail application, and the like. A synchronization application (not shown) also resides on the system 600 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the system 600 described herein.

The system 600 has a power supply 670, which may be implemented as one or more batteries. The power supply 670 might further include an external power source, such as an AC adapter or a powered docking cradle that supplements or recharges the batteries.

The system 600 may also include a radio interface layer 672 that performs the function of transmitting and receiving radio frequency communications. The radio interface layer 672 facilitates wireless connectivity between the system 600 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 600 may further include a video interface 676 that enables an operation of an on-board camera 630 to record still images, video stream, and the like.

It will be appreciated that system 600 may have additional features or functionality. For example, system 600 may also include additional data storage devices (removable and/or non-removable) such as, magnetic disks, optical disks, or tape. Such additional storage is illustrated in FIG. 6 by the non-volatile storage area 668.

Data/information generated or captured and stored via the system 600 may be stored locally, as described above, or the data may be stored on any number of storage media that may be accessed by the device via the radio interface layer 672 or via a wired connection between the system 600 and a separate computing device associated with the system 600, for example, a server computer in a distributed computing network, such as the Internet. As should be appreciated, such data/information may be accessed via the radio interface layer 672 or via a distributed computing network. Similarly, such data/information may be readily transferred between computing devices for storage and use according to any of a variety of data/information transfer and storage means, including electronic mail and collaborative data/information sharing systems.

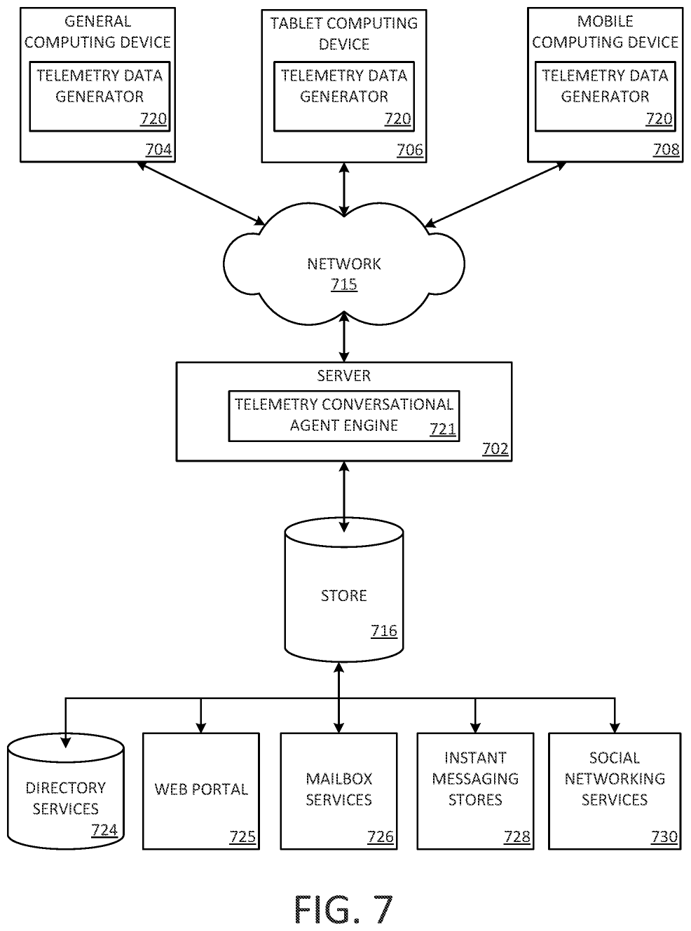

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 724, a web portal 725, a mailbox service 726, an instant messaging store 728, or a social networking site 730.

A telemetry data generator 720 may be employed by a client that communicates with server device 702. Additionally, or alternatively, telemetry conversational agent engine 721 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these examples of the computing devices may obtain content from the store 716, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, cause the system to perform a set of operations. The set of operations comprises: obtaining telemetry data corresponding to an execution environment; obtaining a semantic event index associated with the execution environment, wherein the semantic event index includes: a definition for an event within the telemetry data; and context information for the event; generating a prompt for a generative machine learning model that includes natural language input and the semantic event index, thereby enabling the generative machine learning model to attach semantic meaning to one or more events of the telemetry data; generating, using the generative machine learning model, model output for the telemetry data based on the prompt; and providing an indication of the model output for the telemetry data. In an example, the prompt further comprises an indication of the obtained telemetry data. In another example, the set of operations further comprises generating a set of embeddings based on the telemetry data; and generating the model output further comprises providing the set of embeddings for processing by the generative machine learning model. In a further example, the natural language input is received, from a computing device, as a request for model output; and the indication of the model output is provided, to the computing device, in response to the request. In yet another example, the request is a first request; the model output is first model output; and the set of operations further comprises: receiving, from the computing device, a second request for model output relating to the telemetry data; generating, using the generative machine learning model, second model output for the telemetry data based on natural language input of the second request and the semantic event index; and providing, in response to the second request, an indication of the second model output. In a further still example, the natural language input is selected from a predefined set of conversational inputs to programmatically process the telemetry data using the generative machine learning model. In another example, the generative machine learning model is finetuned to process telemetry data corresponding to the execution environment.

In another aspect, the technology relates to a method for processing telemetry data. The method comprises: obtaining telemetry data corresponding to an execution environment; generating a prompt for a generative machine learning model that includes natural language input; processing, using the generative machine learning model, telemetry data based on the prompt to generate model output, thereby interpreting the telemetry data using the generative machine learning model; and providing an indication of the model output for the telemetry data. In an example, the prompt further comprises a semantic event index associated with the execution environment, thereby enabling the generative machine learning model to attach semantic meaning to one or more events of the telemetry data. In another example, the generative machine learning model is finetuned to process telemetry data corresponding to the execution environment. In a further example, the prompt further comprises an indication of the obtained telemetry data. In yet another example, the method further comprises generating a set of embeddings based on the telemetry data; and processing the telemetry data using the generative machine learning model further comprises providing the set of embeddings for processing by the generative machine learning model. In a further still example, the natural language input is at least one of: received, from a computing device, as natural language user input by a user of the computing device; or obtained from a predefined set of conversational inputs.

In a further aspect, the technology relates to another method for processing telemetry data. The method comprises: obtaining telemetry data corresponding to an execution environment; obtaining a semantic event index associated with the execution environment, wherein the semantic event index includes: a definition for an event within the telemetry data; and context information for the event; generating a prompt for a generative machine learning model that includes natural language input and the semantic event index, thereby enabling the generative machine learning model to attach semantic meaning to one or more events of the telemetry data; generating, using the generative machine learning model, model output for the telemetry data based on the prompt; and providing an indication of the model output for the telemetry data. In an example, the prompt further comprises an indication of the obtained telemetry data. In another example, the method further comprises generating a set of embeddings based on the telemetry data; and generating the model output further comprises providing the set of embeddings for processing by the generative machine learning model. In a further example, the natural language input is received, from a computing device, as a request for model output; and the indication of the model output is provided, to the computing device, in response to the request. In yet another example, the request is a first request; the model output is first model output; and the set of operations further comprises: receiving, from the computing device, a second request for model output relating to the telemetry data; generating, using the generative machine learning model, second model output for the telemetry data based on natural language input of the second request and the semantic event index; and providing, in response to the second request, an indication of the second model output. In a further still example, the natural language input is selected from a predefined set of conversational inputs to programmatically process the telemetry data using the generative machine learning model. In another example, the generative machine learning model is finetuned to process telemetry data corresponding to the execution environment.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
obtaining telemetry data corresponding to an execution environment;
obtaining a semantic event index associated with the execution environment, wherein the semantic event index includes:
a definition for an event within the telemetry data; and
context information for the event;
generating a prompt for a generative machine learning model that includes natural language input and the semantic event index, thereby enabling the generative machine learning model to attach semantic meaning to one or more events of the telemetry data;
generating, using the generative machine learning model, model output for the telemetry data based on the prompt; and
providing an indication of the model output for the telemetry data.

2. The system of claim 1, wherein the prompt further comprises an indication of the obtained telemetry data.

3. The system of claim 1, wherein:
the set of operations further comprises generating a set of embeddings based on the telemetry data; and
generating the model output further comprises providing the set of embeddings for processing by the generative machine learning model.

4. The system of claim 1, wherein:
the natural language input is received, from a computing device, as a request for model output; and
the indication of the model output is provided, to the computing device, in response to the request.

5. The system of claim 4, wherein:
the request is a first request;
the model output is first model output; and
the set of operations further comprises:
receiving, from the computing device, a second request for model output relating to the telemetry data;
generating, using the generative machine learning model, second model output for the telemetry data based on natural language input of the second request and the semantic event index; and
providing, in response to the second request, an indication of the second model output.

6. The system of claim 1, wherein the natural language input is selected from a predefined set of conversational inputs to programmatically process the telemetry data using the generative machine learning model.

7. The system of claim 1, wherein the generative machine learning model is finetuned to process telemetry data corresponding to the execution environment.

8. A method for processing telemetry data, comprising:
obtaining telemetry data corresponding to an execution environment;
generating a prompt for a generative machine learning model that includes natural language input;
processing, using the generative machine learning model, telemetry data based on the prompt to generate model output, thereby interpreting the telemetry data using the generative machine learning model; and
providing an indication of the model output for the telemetry data.

9. The method of claim 8, wherein the prompt further comprises a semantic event index associated with the execution environment, thereby enabling the generative machine learning model to attach semantic meaning to one or more events of the telemetry data.

10. The method of claim 8, wherein the generative machine learning model is finetuned to process telemetry data corresponding to the execution environment.

11. The method of claim 8, wherein the prompt further comprises an indication of the obtained telemetry data.

12. The method of claim 8, wherein:
the method further comprises generating a set of embeddings based on the telemetry data; and
processing the telemetry data using the generative machine learning model further comprises providing the set of embeddings for processing by the generative machine learning model.

13. The method of claim 8, wherein the natural language input is at least one of:
received, from a computing device, as natural language user input by a user of the computing device; or
obtained from a predefined set of conversational inputs.

14. A method for processing telemetry data, the method comprising:
obtaining telemetry data corresponding to an execution environment;
obtaining a semantic event index associated with the execution environment, wherein the semantic event index includes:
a definition for an event within the telemetry data; and
context information for the event;
generating a prompt for a generative machine learning model that includes natural language input and the semantic event index, thereby enabling the generative machine learning model to attach semantic meaning to one or more events of the telemetry data;
generating, using the generative machine learning model, model output for the telemetry data based on the prompt; and
providing an indication of the model output for the telemetry data.

15. The method of claim 14, wherein the prompt further comprises an indication of the obtained telemetry data.

16. The method of claim 14, wherein:
the method further comprises generating a set of embeddings based on the telemetry data; and
generating the model output further comprises providing the set of embeddings for processing by the generative machine learning model.

17. The method of claim 14, wherein:
the natural language input is received, from a computing device, as a request for model output; and
the indication of the model output is provided, to the computing device, in response to the request.

18. The method of claim 17, wherein:
the request is a first request;
the model output is first model output; and
the set of operations further comprises:
receiving, from the computing device, a second request for model output relating to the telemetry data;
generating, using the generative machine learning model, second model output for the telemetry data based on natural language input of the second request and the semantic event index; and
providing, in response to the second request, an indication of the second model output.

19. The method of claim 14, wherein the natural language input is selected from a predefined set of conversational inputs to programmatically process the telemetry data using the generative machine learning model.

20. The method of claim 14, wherein the generative machine learning model is finetuned to process telemetry data corresponding to the execution environment.
